(19) United States
(12) Patent Application Publication
(10) Pub. No.: US 2025/0187390 A1
(43) Pub. Date: Jun. 12, 2025

(54) VEHICLE

(71) Applicant: HONDA MOTOR CO., LTD., Tokyo (JP)

(72) Inventors: Keiji TOJO, Tokyo (JP); Akira INOUE, Tokyo (JP)

(73) Assignee: HONDA MOTOR CO., LTD., Tokyo (JP)

(21) Appl. No.: 18/964,705

(22) Filed: Dec. 2, 2024

(30) Foreign Application Priority Data
Dec. 6, 2023 (JP) 2023-206025

(51) Int. Cl. B60H 1/00; B60L 58/26; B60L 58/27

(52) U.S. Cl. CPC B60H 1/00278; B60H 1/00885; B60L 58/26; B60L 58/27; B60H 2001/00307; B60H 2001/00928

(57) ABSTRACT

A vehicle including: a first valve that switches between a communication state in which a drive device cooling circuit and a battery cooling circuit communicate with each other and a non-communication state; a second valve switches between a bypass state in which a first coolant flowing the drive device cooling circuit bypasses a radiator and a non-bypass state; and a chiller that exchanges heat between the first coolant flowing through the battery cooling circuit and a second coolant flowing through a refrigeration cycle for air conditioning, in which a control device operates the electric heater provided in the battery cooling circuit to perform an electricity waste control, and changes connection states of the first valve and the second valve in accordance with an outside air temperature to change a heat radiation unit of heat generated by the electric heater in the electricity waste control.

### CROSS-REFERENCE TO RELATED APPLICATIONS

This application is based on and claims priority under 35 USC 119 from Japanese Patent Application No. 2023-206025 filed on Dec. 6, 2023, the entire content of which is incorporated herein by reference.

### TECHNICAL FIELD

The present invention relates to a vehicle including a battery.

### BACKGROUND ART

In recent years, efforts to realize a low-carbon society or a decarbonized society become active, and research and development about an electrification technique are conducted to reduce CO₂ emission and improve energy efficiency in vehicles.

In an electric vehicle including a battery, the vehicle can be braked by regeneration of a motor (hereinafter, referred to as motor regeneration). However, since the motor regeneration cannot be performed in a fully charged state of the battery, it is necessary to brake the vehicle by a friction brake. When a frequency of use of the friction brake is high, a size of a brake pad is increased. Therefore, it is desired to perform an electricity waste control such that the motor regeneration can be performed regardless of a state of charge of the battery.

As a thermal management system for an electric vehicle, U.S. Pat. No. 11,390,135B discloses a circuit in which a battery cooling circuit and a circuit for air conditioning provided with a heater core are connected.

In the circuit of U.S. Pat. No. 11,390,135B, the battery cooling circuit and the circuit for air conditioning provided with the heater core are connected, and thus there is a possibility that air conditioning in a passenger compartment is affected when the battery cooling circuit is used to perform electricity waste. In the electricity waste control, it is necessary to adjust a heat balance, and there is a possibility that heat cannot be appropriately radiated when an outside air temperature fluctuates.

An object of the present invention is to provide a vehicle capable of performing an electricity waste control without affecting air conditioning and appropriately radiating heat generated by the electricity waste control.

### SUMMARY OF INVENTION

According to an aspect of the present invention, there is provided a vehicle, including:
a battery;
a drive device including a motor;
a drive device cooling circuit configured to allow a first coolant to flow and adjust a temperature of the drive device;
a battery cooling circuit configured to allow the first coolant to flow and adjust a temperature of the battery;
a refrigeration cycle for air conditioning including an electric compressor, a condenser, an outdoor heat exchanger, and an evaporator, and configured to allow a second coolant to flow;
a control device;
a first valve configured to switch between a communication state in which the drive device cooling circuit and the battery cooling circuit communicate with each other and a non-communication state in which the drive device cooling circuit and the battery cooling circuit discommunicate with each other;
a second valve configured to switch between a bypass state in which the drive device cooling circuit is configured to allow the first coolant to flow through a bypass flow path bypassing a radiator provided in the drive device cooling circuit and a non-bypass state in which the drive device cooling circuit is configured to allow the first coolant to flow through the radiator;
a chiller configured to exchange heat between the first coolant flowing through the battery cooling circuit and the second coolant flowing through the refrigeration cycle; and
an electric heater provided in the battery cooling circuit, in which
the control device is configured to operate the electric heater to perform an electricity waste control when an electricity storage amount in the battery is equal to or greater than a predetermined amount, and
the control device is configured to change connection states of the first valve and the second valve in accordance with an outside air temperature to change a heat radiation unit of heat generated by the electric heater in the electricity waste control.

### BRIEF DESCRIPTION OF DRAWINGS

FIG. 1 is a circuit diagram illustrating a configuration of a coolant circuit 1 provided in a vehicle V;

FIG. 2 is an illustration diagram showing a flow of a coolant according to switching states of a first switching valve 52 (shut-off state) and a second switching valve 54 (non-bypass state) in the coolant circuit 1 of FIG. 1;

FIG. 3 is an illustration diagram showing a flow of the coolant according to the switching states of the first switching valve 52 (communication state) and the second switching valve 54 (bypass state) in the coolant circuit 1 of FIG. 1;

FIG. 4 is an illustration diagram showing a flow of the coolant in a first electricity waste control mode (normal electricity waste control) in the coolant circuit 1 of FIG. 1;

FIG. 5 is an illustration diagram showing a flow of the coolant in a second electricity waste control mode (normal electricity waste control (with a heating request)) in the coolant circuit 1 of FIG. 1;

FIG. 6 is an illustration diagram showing a flow of the coolant in a third electricity waste control mode (electricity waste control under low outside air temperature) in the coolant circuit 1 of FIG. 1;

FIG. 7 is an illustration diagram showing a flow of the coolant in a fourth electricity waste control mode (electricity waste control under low outside air temperature (with a heating request)) in the coolant circuit 1 of FIG. 1; and

FIG. 8 is a schematic configuration diagram of the vehicle V.

### DESCRIPTION OF EMBODIMENTS

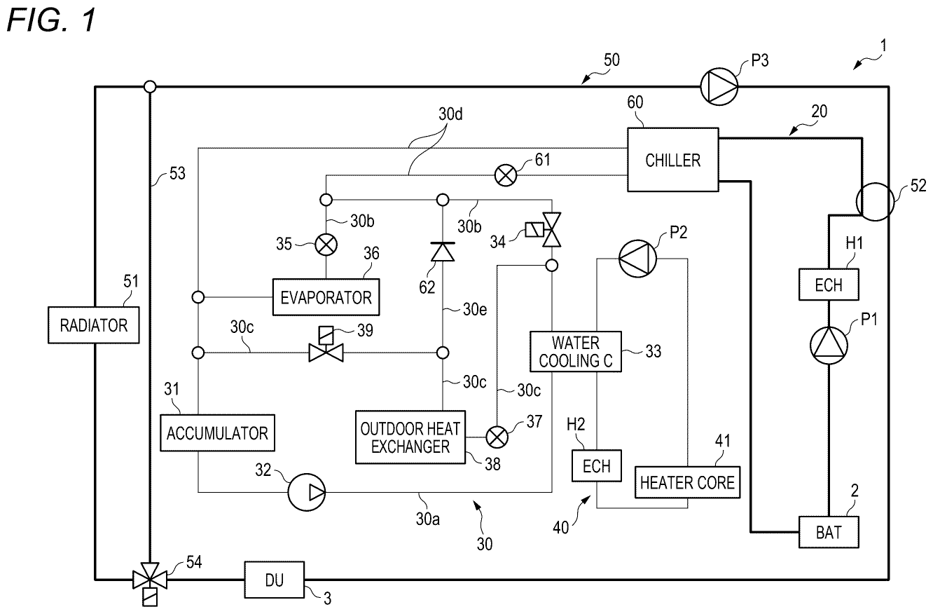

Hereinafter, an embodiment of the present invention will be described with reference to FIGS. 1 to 8.

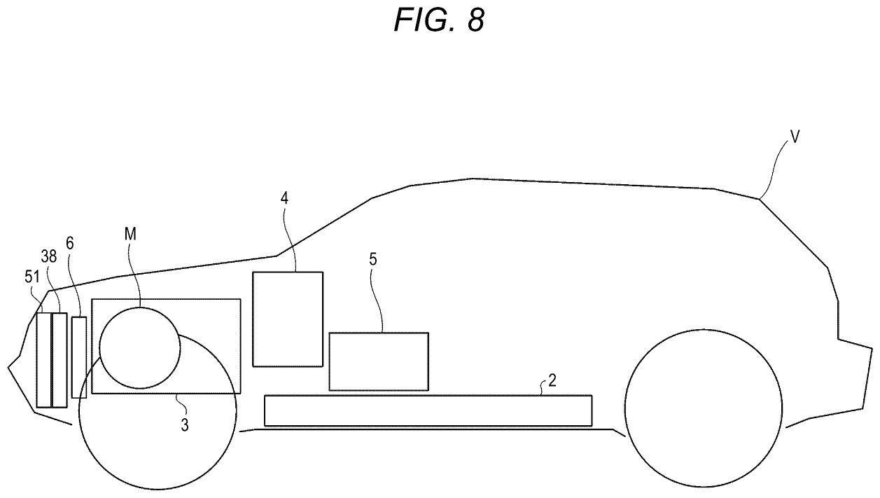

As shown in FIG. 8, a vehicle V is an electric vehicle including a battery 2, a drive device 3 that drives the vehicle V to travel by electric power supplied from the battery 2, an HVAC 4 that controls air conditioning in a passenger compartment, and a control device 5. The drive device 3 includes a heat source such as a motor M, an inverter, a DC-DC converter, and a charger. The HVAC 4 includes an evaporator 36 of a refrigeration cycle 30 (described later) and a heater core 41 of a heating circuit 40 (described later). A radiator 51 of a drive device cooling circuit 50 (described later), an outdoor heat exchanger 38 of the refrigeration cycle 30, and an electric fan 6 for promoting heat radiation and/or heat absorption of the radiator 51 and the outdoor heat exchanger 38 are provided at a front side of the vehicle V.

A coolant circuit 1 shown in FIG. 1 is mounted on the vehicle V. The coolant circuit 1 includes a battery cooling circuit 20, the refrigeration cycle 30, the heating circuit 40, the drive device cooling circuit 50, and a chiller 60.

In the battery cooling circuit 20, the first coolant flows, and a temperature of the battery 2 (BAT) is adjusted. The battery cooling circuit 20 includes the battery 2, a first pump P1 that circulates a first coolant in the battery cooling circuit 20, and a first electric heater H1 (ECH) that can heat the first coolant. The first coolant is, for example, a long life coolant (LLC).

In the refrigeration cycle 30, a second coolant flows, and air-conditioning of the passenger compartment is performed. The refrigeration cycle 30 includes a shared flow path 30a shared during cooling and heating, a flow path for cooling 30b used during cooling, a flow path for heating 30c used during heating, and a connection flow path 30e connecting the flow path for cooling 30b and the flow path for heating 30c. The second coolant is, for example, an air conditioner coolant.

The shared flow path 30a includes an accumulator 31 that separates the vaporized second coolant and the liquid second coolant, an electric compressor 32 that compresses the vaporized second coolant, and a condenser 33 (water cooling C) that absorbs heat from the compressed second coolant having a high pressure and a high temperature and liquefies the second coolant. Since the condenser 33 is provided at a downstream side of the electric compressor 32 in a flow direction of the second coolant, heat of the compressed second coolant having a high pressure and a high temperature can be supplied to the heating circuit 40 via the condenser 33.

The flow path for cooling 30b includes a high pressure solenoid valve 34 that switches between the flow path for cooling 30b and the flow path for heating 30c at a downstream side of the condenser 33, an expansion valve for cooling 35 that vaporizes the second coolant, and an evaporator 36 that absorbs heat from air in the passenger compartment by the second coolant having a low pressure and a low temperature.

The flow path for heating 30c includes an expansion valve for heating 37 that can vaporize the second coolant at the downstream side of the condenser 33, the outdoor heat exchanger 38 that absorbs heat from outside air by the second coolant having a low pressure and a low temperature and radiates heat to the outside air by the second coolant having a high temperature and a high pressure, and a low pressure solenoid valve 39 that switches between the flow path for cooling 30b and the flow path for heating 30c.

The connection flow path 30e is disposed to connect the outdoor heat exchanger 38 and the low pressure solenoid valve 39 of the flow path for heating 30c, and to connect the high pressure solenoid valve 34 and the expansion valve for cooling 35 of the flow path for cooling 30b, and is provided with a check valve 62 in the middle.

In the heating circuit 40, the third coolant flows, and the passenger compartment is heated. The heating circuit 40 includes a second pump P2 that circulates a third coolant in the heating circuit 40, a second electric heater H2 (ECH) that can heat the third coolant, and a heater core 41 that heats the passenger compartment by heat exchange with the third coolant. The third coolant is, for example, LLC.

The third coolant and the first coolant may be the same type of coolant, but the first coolant, the second coolant, and the third coolant flow independently and do not mix with each other. Therefore, an operation of the battery cooling circuit 20 can be prevented from affecting the refrigeration cycle 30.

The heating circuit 40 passes through the inside of the condenser 33 at a downstream side of the second pump P2. The condenser 33 is configured to exchange heat between the second coolant circulating in the refrigeration cycle 30 and the third coolant circulating in the heating circuit 40.

In the drive device cooling circuit 50, the first coolant flows, and the drive device 3 (DU) is cooled. The drive device cooling circuit 50 includes a third pump P3 that circulates the first coolant in the drive device cooling circuit 50, the drive device 3, and the radiator 51 that cools the first coolant.

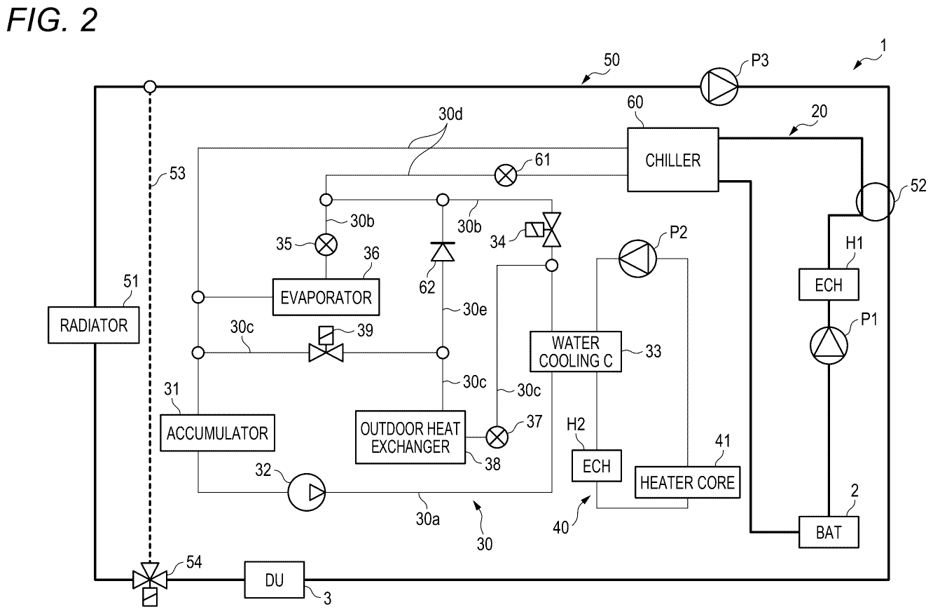

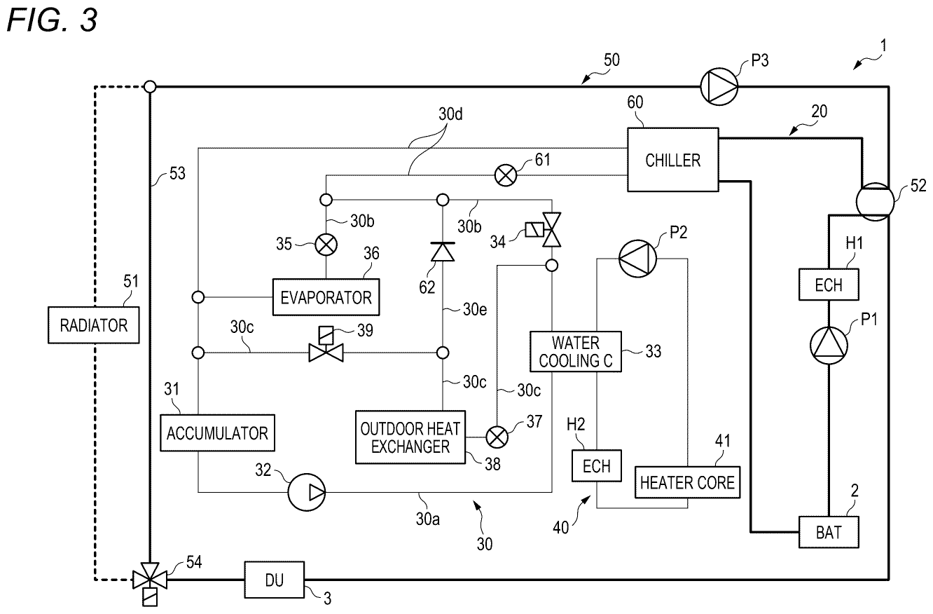

The drive device cooling circuit 50 is communicably connected to the battery cooling circuit 20 via a first switching valve 52. The first switching valve 52 is, for example, a four-way valve, and switches between a communication state (see FIG. 3) in which communication between the drive device cooling circuit 50 and the battery cooling circuit 20 is allowed and a shut-off state (see FIG. 2) in which the communication between the drive device cooling circuit 50 and the battery cooling circuit 20 is shut off.

The drive device cooling circuit 50 includes a bypass flow path 53 bypassing the radiator 51 and a second switching valve 54 disposed at a branch point of the bypass flow path 53. The second switching valve 54 is, for example, a three-way valve, and switches between a bypass state (see FIG. 3) in which the first coolant passes through the bypass flow path 53 and a non-bypass state (see FIG. 2) in which the first coolant passes through the radiator 51.

The chiller 60 is configured to exchange heat between the first coolant flowing through the battery cooling circuit 20 and the second coolant flowing through the refrigeration cycle 30. The first coolant in the battery cooling circuit 20 passes through the inside of the chiller 60 at a downstream side of the first switching valve 52 and an upstream side of the battery 2. The second coolant flowing through the refrigeration cycle 30 passes through the inside of the chiller 60 via a chiller connection flow path 30d connected to the flow path for cooling 30b. The chiller connection flow path 30d is provided with an expansion valve for chiller 61 for the second coolant to absorb heat from the chiller 60.

In the coolant circuit 1 configured as described above, by switching the first switching valve 52, the communication between the drive device cooling circuit 50 and the battery cooling circuit 20 can be allowed or shut off, and the battery 2 can be cooled via the radiator 51 and/or the chiller 60.

However, the electric vehicle can brake the vehicle by motor regeneration, but cannot perform the motor regeneration when the battery 2 is in a fully charged state. In order to brake the vehicle V by the motor regeneration even in the fully charged state of the battery 2, it is necessary to perform an electricity waste control of consuming electric power more than electric power charged by the motor regeneration.

The vehicle Vis provided with the control device 5 (see FIG. 8) that controls the coolant circuit 1. When an electricity storage amount of the battery 2 is equal to or greater than a predetermined value, the control device 5 operates an electrical device of the coolant circuit 1 to perform the electricity waste control, and enables the motor regeneration.

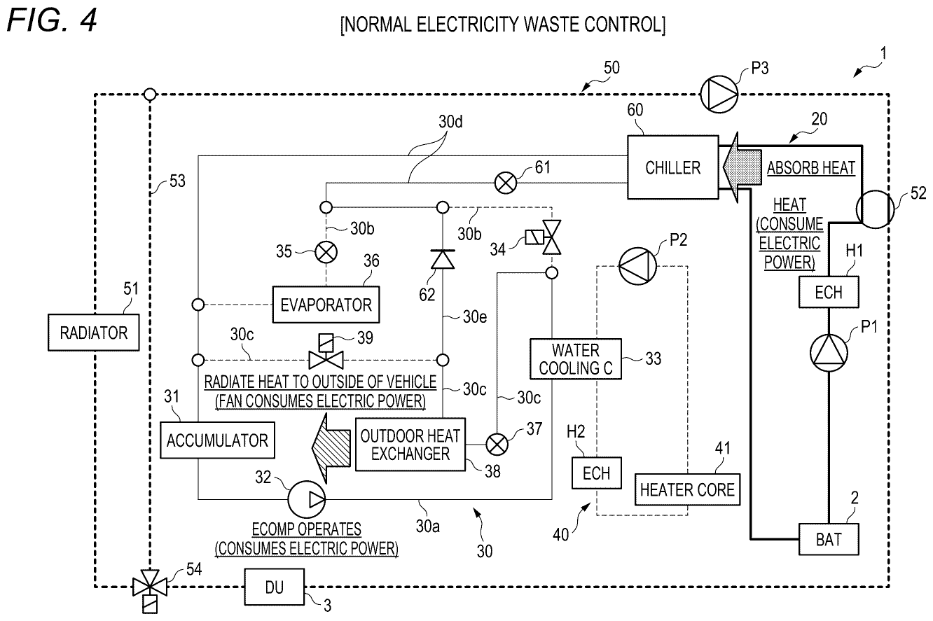

Hereinafter, four electricity waste control modes performed by the control device 5 will be described with reference to FIGS. 4 to 7.

A first electricity waste control mode (normal electricity waste control) shown in FIG. 4 is a mode in which the first electric heater H1 of the battery cooling circuit 20 is operated to perform electricity waste, and heat generated by the first electric heater H1 is radiated in the refrigeration cycle 30. The first electricity waste control mode (normal electricity waste control) is selected when an outside air temperature is higher than 0° C. When the outside air temperature is higher than 0° C., the refrigeration cycle 30 can be effectively used. In this mode, the first switching valve 52 is in a non-communication state, the high pressure solenoid valve 34 is in a closed state, the low pressure solenoid valve 39 is in a closed state, and the electric compressor 32 and the electric fan 6 of the outdoor heat exchanger 38 are operated.

In this state, the second coolant in the refrigeration cycle 30 flows in the order of the electric compressor 32, the condenser 33, the expansion valve for heating 37, the outdoor heat exchanger 38, the check valve 62, the expansion valve for chiller 61, the chiller 60, and the accumulator 31, and the second coolant having a low pressure and a low temperature due to the expansion valve for chiller 61 absorbs heat from the first coolant in the battery cooling circuit 20 in the chiller 60. Thereafter, the second coolant that absorbs heat is compressed by the electric compressor 32 to have a high pressure and a high temperature, and passes through the expansion valve for heating 37 and reaches the outdoor heat exchanger 38, and heat of the second coolant is radiated to the outside of the vehicle by the heat exchange with the outside air.

That is, when the first electric heater H1 of the battery cooling circuit 20 is operated, the first coolant is heated, but the first coolant is cooled by the chiller 60, and the second coolant heated by absorbing heat from the first coolant is cooled by the outdoor heat exchanger 38, and thus a heat balance of the coolant circuit 1 can be adjusted.

In this mode, not only electric power is consumed by the first electric heater H1 of the battery cooling circuit 20, but also electric power consumption can be increased by the operation of the electric compressor 32 and the electric fan 6 of the outdoor heat exchanger 38.

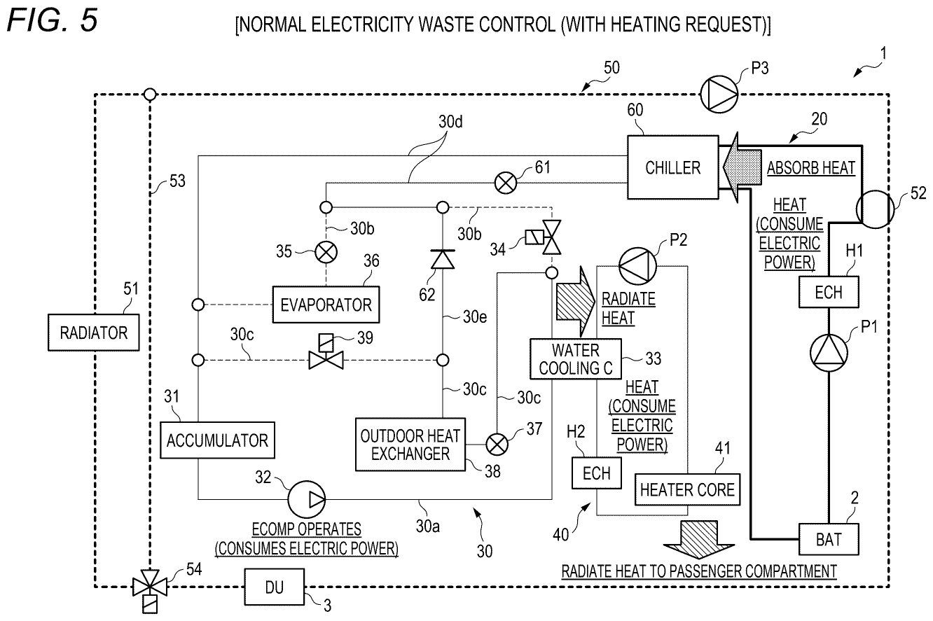

A second electricity waste control mode (normal electricity waste control+heating) shown in FIG. 5 is a mode in which the first electric heater H1 of the battery cooling circuit 20 and the second electric heater H2 of the heating circuit 40 are operated to perform the electricity waste, and heat generated by the first electric heater H1 and the second electric heater H2 of the heating circuit 40 is radiated in the heating circuit 40. The second electricity waste control mode (normal electricity waste control+heating) is selected when the outside air temperature is higher than 0° C. and a heating request of an occupant is present. In this mode, the first switching valve 52 is in the non-communication state, the high pressure solenoid valve 34 is in the closed state, the low pressure solenoid valve 39 is in the closed state, and the electric compressor 32 is operated.

In this state, the second coolant in the refrigeration cycle 30 flows in the order of the electric compressor 32, the condenser 33, the expansion valve for heating 37, the outdoor heat exchanger 38, the check valve 62, the expansion valve for chiller 61, the chiller 60, and the accumulator 31, and the second coolant having a low pressure and a low temperature due to the expansion valve for chiller 61 absorbs heat from the first coolant in the battery cooling circuit 20 in the chiller 60. Thereafter, the second coolant that absorbs heat is compressed by the electric compressor 32 to have a high pressure and a high temperature, and radiates heat to the third coolant of the heating circuit 40 in the condenser 33. In the heating circuit 40, heat transferred from the refrigeration cycle 30 and heat generated by the second electric heater H2 are radiated from the heater core 41 to the passenger compartment.

That is, when the first electric heater H1 of the battery cooling circuit 20 is operated, the first coolant is heated, but the first coolant is cooled by the chiller 60. The second coolant heated by absorbing heat from the first coolant is cooled by the condenser 33. Furthermore, the third coolant heated by absorbing heat from the second coolant is further heated by the second electric heater H2 of the heating circuit 40, but is cooled by the heater core 41 during heating. Therefore, the heat balance of the coolant circuit 1 can be adjusted.

In this mode, not only electric power is consumed by the first electric heater H1 of the battery cooling circuit 20, but also electric power is consumed by the electric compressor 32 and the second electric heater H2, and the power consumption can further increase. In a situation where an occupant issues the heating request to use air conditioning, the operation of the second electric heater H2 does not cause the occupant to feel uncomfortable.

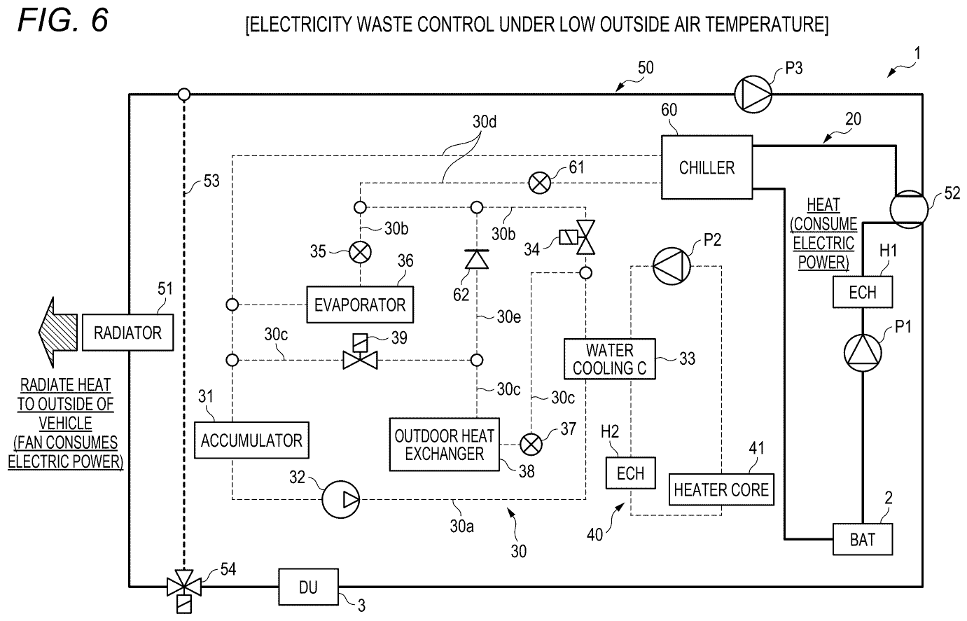

A third electricity waste control mode (electricity waste control under low outside air temperature) shown in FIG. 6 is a mode in which the first electric heater H1 of the battery cooling circuit 20 is operated to perform electricity waste, and heat generated by the first electric heater H1 is radiated by the drive device cooling circuit 50. The third electricity waste control mode (electricity waste control under low outside air temperature) is selected when the outside air temperature is equal to or lower than 0° C. (equal to or lower than a freezing point). When the outside air temperature is equal to or lower than 0° C., an amount of the second coolant staying in the condenser 33 increases, and thus there is a possibility that a flow rate of the second coolant flowing through the refrigeration cycle 30 decreases and the electric compressor 32 cannot operate normally. Therefore, when the outside air temperature is equal to or lower than 0° C., a heat radiation unit is made different from that in the first electricity waste control mode (normal electricity waste control) without using the refrigeration cycle 30. In this mode, the first switching valve 52 is in the communication state, the second switching valve 54 is in the non-bypass state, and the electric fan 6 of the radiator 51 is operated.

In this state, the communication between the battery cooling circuit 20 and the drive device cooling circuit 50 is allowed, and thus the heat generated by the first electric heater H1 is radiated to the outside of the vehicle in the radiator 51.

That is, when the first electric heater H1 of the battery cooling circuit 20 is operated, the first coolant is heated, but the first coolant is cooled by the radiator 51, and thus the heat balance of the coolant circuit 1 can be adjusted.

In this mode, not only electric power is consumed by the first electric heater H1 of the battery cooling circuit 20, but also electric power consumption can be increased by the operation of the electric fan 6 of the radiator 51.

In this way, the first electricity waste control mode (normal electricity waste control) and the third electricity waste control mode (electricity waste control under low outside air temperature) are switched in accordance with the outside air temperature, and the heat radiation unit of heat generated by the first electric heater H1 of the battery cooling circuit 20 is changed, so that it is possible to appropriately radiate heat generated by the operation of the first electric heater H1 in the electricity waste control regardless of the outside air temperature. Switching between the first electricity waste control mode (normal electricity waste control) and the third electricity waste control mode (electricity waste control under low outside air temperature) is realized by switching between the first switching valve 52 and the second switching valve 54 as described above. Switching between the first electricity waste control mode (normal electricity waste control) and the third electricity waste control mode (electricity waste control under low outside air temperature) is not necessarily limited to the case where the outside air temperature is 0° C., and can be appropriately set.

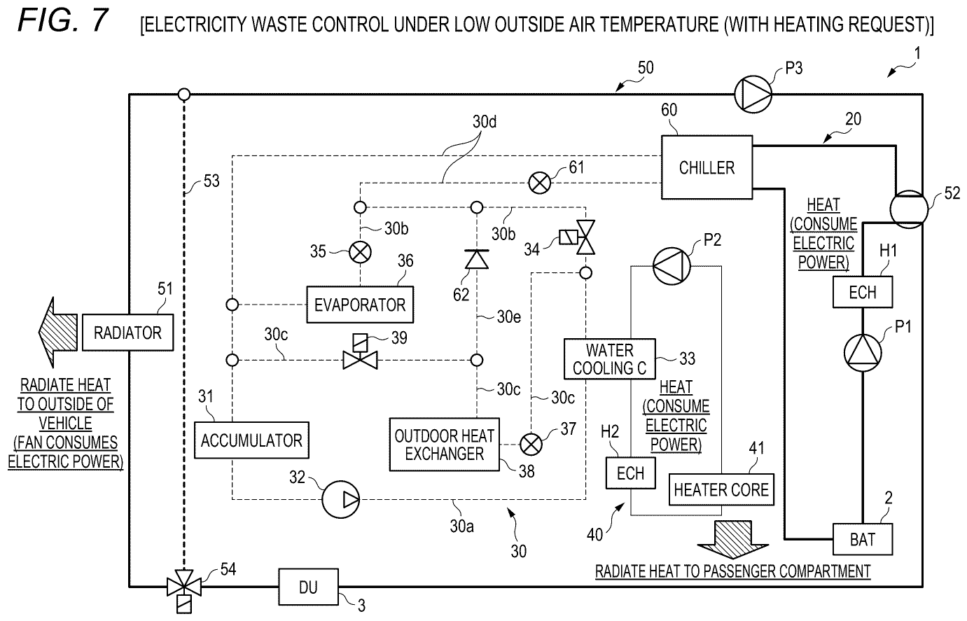

A fourth electricity waste control mode (electricity waste control under low outside air temperature+heating) shown in FIG. 7 is a mode in which the first electric heater H1 of the battery cooling circuit 20 and the second electric heater H2 of the heating circuit 40 are operated to perform the electricity waste, and heat generated by the first electric heater H1 and the second electric heater H2 is radiated in the drive device cooling circuit 50 and the heating circuit 40. The fourth electricity waste control mode (electricity waste control under low outside air temperature+heating) is selected when the outside air temperature is equal to or lower than 0° C. and the heating request of the occupant is present. In this mode, similarly to the third electricity waste control mode (electricity waste control under low outside air temperature), the first switching valve 52 is in the communication state, the second switching valve 54 is in the non-bypass state, and the electric fan 6 of the radiator 51 is operated.

In this state, the communication between the battery cooling circuit 20 and the drive device cooling circuit 50 is allowed, and thus the heat generated by the first electric heater H1 is radiated to the outside of the vehicle in the radiator 51. The heat generated by the second electric heater H2 is radiated from the heater core 41 to the passenger compartment.

That is, when the first electric heater H1 of the battery cooling circuit 20 is operated, the first coolant is heated, but the first coolant is cooled by the radiator 51. When the second electric heater H2 of the heating circuit 40 is operated, the third coolant is heated, but is cooled by the heater core 41 during the heating. Therefore, the heat balance of the coolant circuit 1 can be adjusted.

In this mode, not only electric power is consumed by the operation of the first electric heater H1 of the battery cooling circuit 20 and the electric fan 6 of the radiator 51, but also electric power is consumed by the second electric heater H2 of the heating circuit 40, and the power consumption can further increase. In a situation where an occupant issues the heating request to use air conditioning, the operation of the second electric heater H2 does not cause the occupant to feel uncomfortable.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, respective constituent elements in the above-described embodiments may be freely combined without departing from the gist of the invention.

In the present specification, at least the following matters are described. Although corresponding constituent elements or the like in the above-described embodiments are shown in parentheses, the present invention is not limited thereto.

(1) A vehicle (vehicle V), including:
a battery (battery 2);
a drive device (drive device 3) including a motor (motor M);
a drive device cooling circuit (drive device cooling circuit 50) configured to allow a first coolant to flow and adjust a temperature of the drive device;
a battery cooling circuit (battery cooling circuit 20) configured to allow the first coolant to flow and adjust a temperature of the battery;
a refrigeration cycle for air conditioning (refrigeration cycle 30) including an electric compressor (electric compressor 32), a condenser (condenser 33), an outdoor heat exchanger (outdoor heat exchanger 38), and an evaporator (evaporator 36), and configured to allow a second coolant to flow;
a control device (control device 5);
a first valve (first switching valve 52) configured to switch between a communication state in which the drive device cooling circuit and the battery cooling circuit communicate with each other and a non-communication state in which the drive device cooling circuit and the battery cooling circuit discommunicate with each other;
a second valve (second switching valve 54) configured to switch between a bypass state in which the drive device cooling circuit is configured to allow the first coolant to flow through a bypass flow path (bypass flow path 53) bypassing a radiator (radiator 51) provided in the drive device cooling circuit and a non-bypass state in which the drive device cooling circuit is configured to allow the first coolant to flow through the radiator;
a chiller (chiller 60) configured to exchange heat between the first coolant flowing through the battery cooling circuit and the second coolant flowing through the refrigeration cycle; and
an electric heater (first electric heater H1) provided in the battery cooling circuit, in which
the control device is configured to operate the electric heater to perform an electricity waste control when an electricity storage amount in the battery is equal to or greater than a predetermined amount, and
the control device is configured to change a connection state of the first valve and the second valve in accordance with an outside air temperature to change a heat radiation unit of heat generated by the electric heater in the electricity waste control.

According to (1), the electric power generated by the motor regeneration can be discarded by operating the electric heater provided in the battery cooling circuit, and thus even when the battery is in a fully charged state, a regenerative brake can be used. Accordingly, it is possible to prevent deterioration and an increase in a size of a friction brake. In this case, since the battery cooling circuit through which the first coolant flows is independent of the refrigeration cycle for air conditioning through which the second coolant flows, it is possible to avoid an influence on air conditioning during electricity waste. By changing the heat radiation unit of heat generated by the electric heater in accordance with the outside air temperature, it is possible to appropriately radiate heat generated by the electric heater in the electricity waste control. Accordingly, a heat balance can be adjusted in the entire circuit.

(2) The vehicle according to (1), in which
the control device is configured, in the electricity waste control, to force the heat to be radiated from the radiator when the outside air temperature is equal to or lower than a first temperature, and
to operate the electric compressor and force the heat to be radiated from the outdoor heat exchanger when the outside air temperature is higher than the first temperature.

According to (2), an electricity waste amount can be increased by operating the electric compressor to radiate heat from the outdoor heat exchanger, and thus when the outside air temperature is high, the electricity waste amount can be increased by radiating heat from the outdoor heat exchanger. On the other hand, when the outside air temperature is low, a capacity of a heating pump of the refrigeration cycle is limited. Therefore, by radiating heat from the radiator when the outside air temperature is low, it is possible to appropriately radiate heat in a situation where the capacity of the heating pump is limited. When the outside air temperature is low, a difference between the outside air temperature and a battery temperature is large, and thus the heat radiation by the radiator is effective.

(3) The vehicle according to (2), in which
the control device is configured, in the electricity waste control,
to set the first valve to the communication state and set the second valve to the non-bypass state to force the heat to be radiated from the radiator when the outside air temperature is equal to or lower than the first temperature, and to set the first valve to the non-communication state and operate the electric compressor to force the heat to be radiated from the outdoor heat exchanger when the outside air temperature is higher than the first temperature.

According to (3), by setting the first valve to the communication state, heat of the electric heater provided in the battery cooling circuit can be radiated using the radiator provided in the drive device cooling circuit. On the other hand, by operating the electric compressor with the first valve in the non-communication state, heat of the electric heater can be radiated by the outdoor heat exchanger while the electric power is consumed by the electric compressor.

(4) The vehicle according to any one of (1) to (3), further including:
a heater core circuit (heating circuit 40) including a heater core (heater core 41) and a second electric heater (second electric heater H2), and configured to allow a third coolant to flow, in which
the condenser is configured to allow a heat exchange between the second coolant flowing through the refrigeration cycle and the third coolant flowing through the heater core circuit, and
the control device is configured, in the electricity waste control, to operate the second electric heater when an occupant uses air conditioning.

According to (4), the electricity waste amount can be increased by operating the second electric heater when the occupant uses air conditioning. When the outside air temperature is low, comfort of the occupant can be improved by heating a passenger compartment.

What is claimed is:

1. A vehicle, comprising:
a battery;
a drive device including a motor;
a drive device cooling circuit configured to allow a first coolant to flow and adjust a temperature of the drive device;
a battery cooling circuit configured to allow the first coolant to flow and adjust a temperature of the battery;
a refrigeration cycle for air conditioning including an electric compressor, a condenser, an outdoor heat exchanger, and an evaporator, and configured to allow a second coolant to flow;
a control device;
a first valve configured to switch between a communication state in which the drive device cooling circuit and the battery cooling circuit communicate with each other and a non-communication state in which the drive device cooling circuit and the battery cooling circuit discommunicate with each other;
a second valve configured to switch between a bypass state in which the drive device cooling circuit is configured to allow the first coolant to flow through a bypass flow path bypassing a radiator provided in the drive device cooling circuit and a non-bypass state in which the drive device cooling circuit is configured to allow the first coolant to flow through the radiator;
a chiller configured to exchange heat between the first coolant flowing through the battery cooling circuit and the second coolant flowing through the refrigeration cycle; and
an electric heater provided in the battery cooling circuit, wherein
the control device is configured to operate the electric heater to perform an electricity waste control when an electricity storage amount in the battery is equal to or greater than a predetermined amount, and
the control device is configured to change connection states of the first valve and the second valve in accordance with an outside air temperature to change a heat radiation unit of heat generated by the electric heater in the electricity waste control.

2. The vehicle according to claim 1, wherein
the control device is configured, in the electricity waste control, to force the heat to be radiated from the radiator when the outside air temperature is equal to or lower than a first temperature, and
to operate the electric compressor and force the heat to be radiated from the outdoor heat exchanger when the outside air temperature is higher than the first temperature.

3. The vehicle according to claim 2 wherein
the control device is configured, in the electricity waste control,
to set the first valve to the communication state and set the second valve to the non-bypass state to force the heat to be radiated from the radiator when the outside air temperature is equal to or lower than the first temperature, and
to set the first valve to the non-communication state and operate the electric compressor to force the heat to be radiated from the outdoor heat exchanger when the outside air temperature is higher than the first temperature.

4. The vehicle according to claim 1, further comprising:
a heater core circuit including a heater core and a second electric heater, and configured to allow a third coolant to flow, wherein
the condenser is configured to allow a heat exchange between the second coolant flowing through the refrigeration cycle and the third coolant flowing through the heater core circuit, and
the control device is configured, in the electricity waste control, to operate the second electric heater when an occupant uses air conditioning.
